(19) United States
(12) Patent Application Publication
(10) Pub. No.: US 2013/0028754 A1
(43) Pub. Date: Jan. 31, 2013

(54) PERISTALTIC SYSTEM, FLUID DELIVERY DEVICE, PIPETTING DEVICE, SLEEVE AND METHOD FOR OPERATING THE PERISTALTIC SYSTEM

(71) Applicant: Joseph Lass, Munchen (DE)

(72) Inventor: Joseph Lass, Munchen (DE)

(73) Assignee: PARItec GmbH, Starnberg (DE)

(21) Appl. No.: 13/575,225

(22) PCT Filed: Jan. 31, 2011
(86) PCT No.: PCT/EP2011/051302

§ 371 Date: Oct. 15, 2012

(30) Foreign Application Priority Data
Jan. 29, 2010 (DE) 10 2010 001 369.2

(51) Int. Cl. F04B 49/00; F04B 47/00; A61H 7/00; F04B 43/12

(52) U.S. Cl. 417/53; 417/474; 137/565.01; 601/151

(57) ABSTRACT

The invention relates to a peristaltic system (50), which comprises at least two pumps (30, 30′) that can be separately actuated, each pump comprising a pump chamber (14) suited for receiving a fluid, a pump element (16) suited for suctioning and displacing a fluid into and from the pump chamber (14), two check valves (12, 12′), one of which (12) is in fluid connection with an inlet of the pump chamber (14) and the other (12′) is in fluid connection with an outlet of the pump chamber (14), and a valve (18) which is closed in the idle state of the pump (30, 30′) and in fluid connection with the check valves (12, 12′). The peristaltic system (50) further comprises a container (40) suited for receiving a fluid, the container being in fluid connection with an inlet of the one pump (30′) and with an outlet of the other pump (30) and flexibly designed at least in some regions such that the volume of the container depends on the volume of a fluid that is received. The invention further relates to a fluid delivery device (100), a pipetting device and a sleeve, which use such a peristaltic system (50), and to a method for operating such a peristaltic system (50).

The present invention relates to a peristaltic system (for example a pump system or system or control for changing the volume of a flexible container) comprising at least two pumps and a flexible container that is suitable for receiving a fluid. The invention also relates to a fluid delivery device, a pipetting device and a sleeve, which use such a peristaltic system, as well as to a method for operating such a peristaltic system.

In peristaltic systems, repeated processes are carried out in series so that, for example, movement of a fluid or a solid body is achieved. Known from the prior art are peristaltic systems that are used for conveying liquids or for moving flexible bodies. Known, inter alia, are physiological, mechanical, electromechanical, hydraulic and other driving principles. Hydraulic driving offers the possibility of a large separation between the generation of force and the application of force. This makes it possible to place small peristaltic actuators in places that are difficult to access and in areas having a small volume.

The article “Regenwürmer als Vorbild für medizinische Instrumente” [Earthworms as a Model for Medical Instruments], S. Oberthür and P. Meier, Mechatronik F&M, No. 11-12 (2005), pages 22 to 25, discloses a peristaltic probe that can move independently though cavities in the human body. The probe consists of three or more segments that can each be hydraulically actuated by means of a corresponding pump. Depending on the operation of the respective pump, this causes a change in the diameter and the length of the corresponding segment. By means of a cyclically repeated actuation of the different segments, a straight-line forward motion of the probe though a cavity can be produced. The actuation of individual segments in connection with the need to intermittently apply a higher pressure thereto and to intermittently apply a lower pressure thereto, as well as to respectively maintain these pressures also over a longer period of time, makes a plurality of controllable elements, such as, for example, valves, pumps, pressure sensors etc., necessary. This leads to an increase in the costs and to an increased space requirement in such systems.

The object of the present invention is to provide a peristaltic system having a small size and a simple construction, as well as a fluid delivery device, a pipetting device and a sleeve, which use such a peristaltic system, and an uncomplicated method for operating such a peristaltic system.

This object is solved by a peristaltic system having the features of claim 1, a fluid delivery device having the features of claim 9, a pipetting device having the features of claim 11, a sleeve having the features of claim 12 and a method having the features of claim 13. Advantageous embodiments can be found in the remaining claims.

The peristaltic system according to the invention comprises at least two separately actuatable pumps, each pump comprising a pump chamber suitable for receiving a fluid, a pump element (active pump chamber wall) that is suitable for suctioning and displacing a fluid into and out of the pump chamber, two check valves, one of which is arranged in fluid connection with an inlet of the pump chamber and the other of which is arranged in fluid connection with an outlet of the pump chamber, and a valve that is closed in the idle state of the pump and is arranged in fluid connection with the check valves. The peristaltic system furthermore comprises at least one container suitable for receiving a fluid, which is arranged in fluid connection with an inlet of the one pump and with an outlet of the other pump and which is flexibly configured, at least in parts, in such a manner that its volume depends on the volume of a received fluid.

The container can be filed with a fluid via the outlet of the one pump and can be emptied via the inlet of the other pump. Since the pumps can be separately actuated, one of the pumps can be respectively operated whilst the other pump is in the idle state. By suitably actuating the pumps, the volume of the container can thus be varied in a simple, efficient and precise manner via the amount of fluid received in the container (the fluid volume in the container). A cyclic repetition of such an actuation of the pumps enables a periodical variation of the container volume. Since the pumps of the system are identically configured and since the change in the container volume can take place, for example, by the sequential activation of the pumps, the system can be operated with just one set of drive electronics (control electronics), which considerably simplifies operability. The power consumption when operating the system can furthermore be reduced in this manner. The system can therefore be supplied with power, for example, by a compact battery, which is in particular advantageous for mobile applications.

The container can be configured, for example, as a balloon, tube or the like, and can be made of a resilient or non-resilient material. By supplying a fluid into the container, an excess pressure is created therein, which leads to an increase in the container volume. If the container is emptied, a vacuum is formed therein and the container volume is accordingly reduced. If the container is made of a resilient material, the resilient restoring force of the container material can contribute to the reduction of the container volume when emptying the container. Also possible is furthermore a container construction in which only part of the container is configured in a flexible manner and the remaining area of the container is configured such that it is rigid. In this case, the flexible container part can be made of a resilient or non-resilient material. In such a construction, a variation of the container volume is achieved by deforming the flexible part of the container, which enables a particularly targeted change in the shape of the container when operating the peristaltic system.

The check valves are respectively arranged in the pump such that they prevent a flow of fluid through the pump in the direction opposite to the delivery direction of the fluid (fluid delivery direction). Since a further valve (NC valve), which is closed in the idle state of the pump, is additionally provided in fluid connection with the check valves, a flow of fluid in the delivery direction is also reliably prevented when the pump is switched off. The pump therefore closes in both directions in the idle state, as a result of which in particular a so-called “free flow”, i.e. a flow of fluid in the delivery direction when the pump is switched off, is prevented. If the peristaltic system according to the invention is switched off, it moves into a stable state since the pumps are in this case brought into the idle state and are thus reliably closed. Thus, no active control valves are required in order to regulate the flow of fluid, and therefore the structure and operability of the system are considerably simplified and the manufacturing costs are reduced. The uncomplicated structure of the system in particular enables production in high quantities with low production costs. The peristaltic system according to the invention can therefore be used particularly advantageously in microelectromechanical systems (MEMS), in which a small size and a low power consumption are very important for compact and mobile applications.

The peristaltic system according to the invention is suitable for use with any type of fluid. Depending on the field of use of the system, a suitable liquid or a suitable gas may be selected as the fluid. However, liquids are preferably used as the fluid since they have a lower compressibility than gases and therefore enable a particularly precise control of the container volume. On the other hand, the use of, for example, air as the fluid allows a particularly simple construction and operation of the system.

The at least two pumps and the container of the peristaltic system preferably form a closed fluid system, i.e. a closed fluid loop, whereby in this case at least one additional container is used as the fluid reservoir. A constant total volume of the fluid is achieved in this manner, which facilitates volume control and enables the adjustment of the maximum fluid pressure in even finer steps, as a result of which an even more precise variation of the container volume is made possible. In this case, a dead volume of the fluid system in particular has no influence on the operation of the system and can therefore be disregarded. Furthermore, if a liquid is used as the fluid, it can be reliably ensured that no air enters the fluid system. The use of pressure sensors is not required, and thus a simple and compact structure of the system is ensured.

The valve which is closed in the idle state of the pump is preferably configured as a passive valve so that no external actuation is required to open and close the same. According to one embodiment of the invention, the valve in at least one of the pumps comprises two chambers, one of which is in fluid connection with the check valve at the inlet of the pump chamber and the other of which is in fluid connection with the check valve at the outlet of the pump chamber, and also comprises a membrane arranged between the chambers. The membrane is configured such that it deforms when the pressure in the chamber at the outlet side exceeds the pressure in the chamber at the inlet side by a predetermined value, as a result of which the valve opens. Such a construction of the valve is simple and cost-effective and allows a reliable and effective prevention of a flow of fluid in the idle state of the pump. Since no moveable parts except for the membrane are required for such a valve, it is furthermore extremely stable and long-lasting.

In at least one of the pumps, the pump element is preferably a membrane. The use of a membrane enables a compact and simple structure of the pump as well as a very precise, accurately controlled fluid transport, in particular for small delivery amounts. Thus, even small changes to the container volume can be achieved with high precision, which is in particular advantageous in the case of containers having a small volume. The membrane can be formed, for example, from a metal or plastic, as a result of which a simple and cost-effective production of the pump is ensured.

According to one embodiment of the invention, the check valves, the valve and the pump chamber and/or the pump element are arranged in one plane, i.e. next to one another, in at least one of the pumps. Either the pump chamber or the pump element, or also both elements together, can hereby be provided in the same plane as the check valves and the valve. This approach allows a particularly compact, space-saving and stable structure of the pump. Such a planar structure of the pump is furthermore very suitable for the use of the system according to the invention in MEMS for multiple parallel production. The elements of the pump can, for example, be arranged one next to the other on a planar carrier substrate, such as a semiconductor, ceramic, plastic or metal substrate, whereby the substrate can also be provided with pump elements on both sides in order to achieve a particularly high packing density. The pump elements provided on both sides of the substrate can hereby be elements of the same pump or of different pumps.

In at least one of the pumps, the pump chamber and/or the pump element and/or the check valves and/or the valve is/are preferably made of silicon, a metal or a plastic. A stable structure and an uncomplicated production of the pump are thus ensured.

According to one embodiment of the invention, the pump chamber, the pump element, the check valves and the valve are fixedly connected to one another in at least one of the pumps, which can further increase the stability and compactness of the pump. The fixed connection of the pump elements with one another can hereby be achieved by mounting the elements on a carrier substrate, as was already explained in detail above.

At least one of the pumps is preferably a micropump, i.e. a pump having a reduced size with dimensions in the millimeter to micrometer range. Such a compact pump structure, in which, for example, a membrane can be used as the pump element, is of great advantage in particular for the use of the system according to the invention in MEMS.

The container of the system according to the invention is furthermore preferably made of a plastic, as a result of which a simpler, more cost-effective, more robust and lighter structure is ensured.

According to one embodiment of the invention, the peristaltic system comprises more than two pumps and at least two containers, with each of the containers respectively being arranged in fluid connection with the inlet of one of the pumps and with the outlet of another one of the pumps. Each of the containers can be filled with a fluid via the outlet of one of the pumps and can be emptied via the inlet of the other of the pumps. Since all of the pumps can be separately actuated, one of the pumps can be respectively operated whilst the other pump is in the idle state. By suitably actuating the pumps, the volumes of the containers can therefore be varied in a simple, efficient and precise manner via the amount of fluid received therein (the fluid volume in the containers). By cyclically repeating such an actuation of the pumps, a periodical variation of the container volumes is made possible. Since the pumps of the system are identically configured, as in the case described above, and since the change in the container volumes can take place, for example, by the sequential activation of the pumps, the system can be operated with just one set of drive electronics (control electronics), which considerably simplifies operability.

The use of at least two containers, the volumes of which can be varied at different times, enables, for example, the use of the peristaltic system for moving fluids in a deformable channel that is arranged close to the system. The system can therefore be used for a fluid delivery device, such as a peristaltic pump, a tube pump or a hydraulic dosing pump, as will be described in detail in the following.

The fluid delivery device according to the invention comprises such a peristaltic system and a deformable channel that is suitable for receiving a fluid, said channel being arranged relative to the containers of the peristaltic system such that a respective change in the volume of one of the containers of the peristaltic system is suitable for bringing about a deformation of a portion of the channel in the vicinity of the corresponding container. By changing the volume of the container, a pressure is hereby exerted on the corresponding channel portion, which leads to a deformation of the same. This pressure can be applied directly to the channel portion by the container or it can be applied via a pressure transfer member, such as, for example, a piston or a suitable intermediate piece, which is arranged between the container and the channel portion. The deformable channel can be configured, for example, as a tube or a flexible pipe. By suitably actuating the pumps of the peristaltic system so as to bring about a suitable variation in the volumes of the different containers, a fluid contained in the channel can be moved along the channel and thus delivered.

According to a further embodiment of the fluid delivery device, this device may also comprise a plurality of peristaltic systems, each having one or more containers, and a deformable channel that is suitable for receiving a fluid, said channel being arranged relative to the containers of the peristaltic systems such that a respective change in the volume of one of the containers of the peristaltic systems is suitable for bringing about a deformation of a portion of the channel in the vicinity of the corresponding container. Such a structure facilitates an independent change in the volumes of the containers since these are controlled via different independent peristaltic systems, and is then in particular advantageous if a fluid connection between the different containers is difficult to realize owing to the specific structure of the fluid delivery device.

The containers are preferably configured as areas of a pipe and the deformable channel is preferably arranged within the pipe. This approach enables a compact and stable structure of the fluid delivery device, which is advantageous in particular in the case of mobile applications.

The invention furthermore provides a pipetting device, which comprises at least one fluid delivery device as described above. Such a pipetting device has a simple and compact structure and is suitable for the precise pipetting also of small amounts of fluid. The pipetting device can be used, for example, for medical, chemical or biological applications. In this case, the reversal of the fluid delivery direction that is to be brought about in a simple manner in the fluid delivery device according to the invention can be particularly advantageously implemented.

The invention also provides a sleeve, for example for medical applications, which comprises at least one peristaltic system as described above and is suitable in particular for lymph drainage. The sleeve is hereby placed on a patient to be treated such that the containers of the system massage a swollen area of the patient's body, such as an area of the arm or leg, by means of a periodical variation of volumes thereof, and can thus bring about drainage of the area. As was already explained above, the compact, simple and stable structure of the peristaltic system is particularly suitable for such mobile applications.

The peristaltic system according to the invention can also be used, for example, in a hydraulically enforced valve.

The method for operating a peristaltic system such as described above comprises the following steps: actuating the pump, the inlet of which is in fluid connection with the container, in order to bring this pump into the idle state, actuating the pump, the outlet of which is in fluid connection with the container, in order to operate this pump such that a fluid is supplied to the container, subsequently actuating the pump, the outlet of which is in fluid connection with the container, in order to bring this pump into the idle state, and actuating the pump, the inlet of which is in fluid connection with the container, in order to operate this pump such that the fluid is discharged out of the container. In this manner, the amount of fluid received in the container (the fluid volume in the container) and thus also the volume of the container can be controlled simply and precisely by means of a separate actuation of the pumps. As was already explained above, the system can hereby be operated with just one set of drive electronics (control electronics), which considerably simplifies the operating process and reduces the production costs and power consumption during operation of the system.

In a peristaltic system such as described above, which comprises more than two pumps and at least two containers, the above method steps can be carried out in a predetermined sequence for each of the containers so as to bring about a suitable variation of the volumes of the different containers. In this manner, as was already explained in detail above, a fluid accommodated in a deformable channel arranged close to the containers can, fcr example, be moved along the channel and thus delivered.

The present invention will be described in the following, purely by way of an example, by means of the enclosed drawings, in which

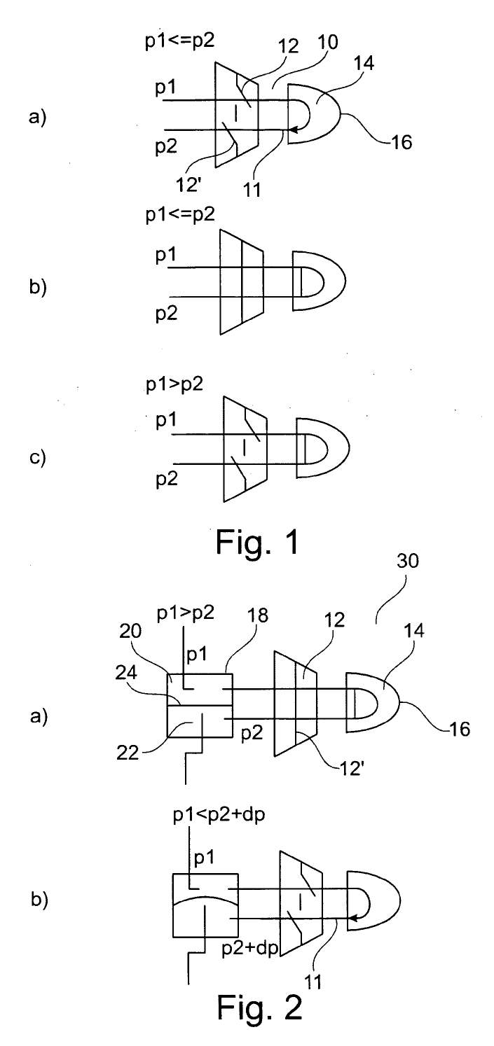

FIGS. 1a) to c) show a schematic representation of a pump having two check valves;

FIGS. 2a) and b) show a schematic representation of a pump having two check valves and a further valve;

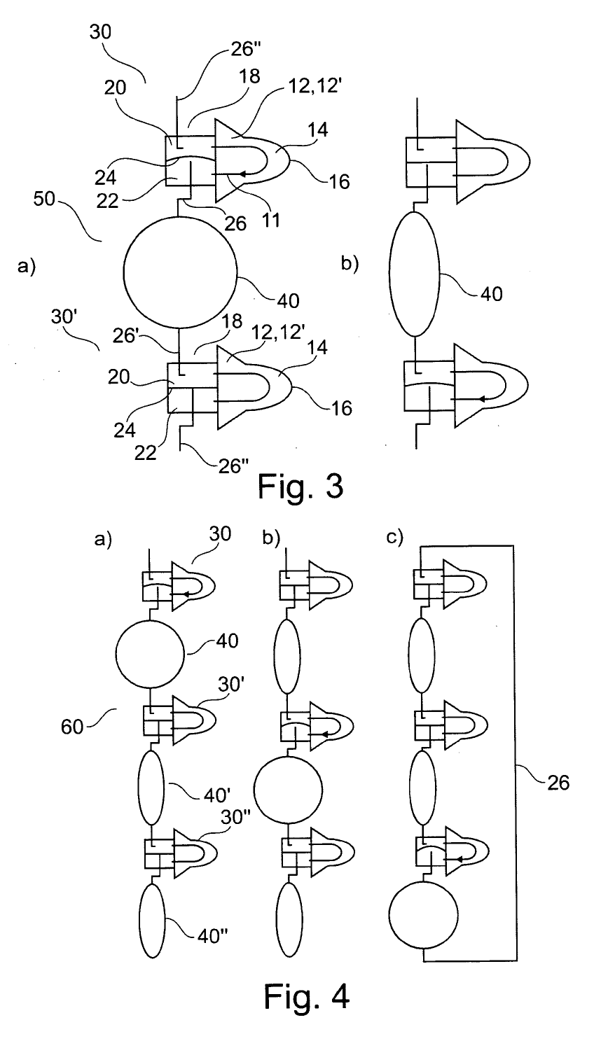

FIGS. 3a) and b) show a schematic representation of a peristaltic system according to one embodiment of the invention;

FIGS. 4a) to c) show a schematic representation of a peristaltic system according to a further embodiment of the invention;

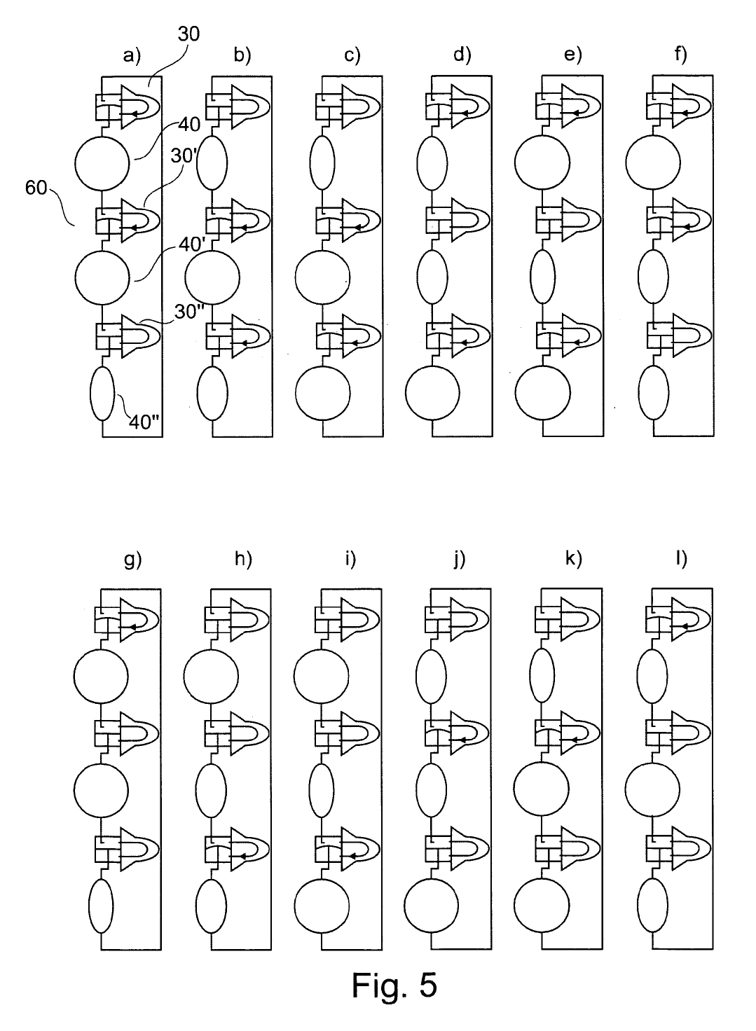

FIGS. 5a) to l) show a schematic representation of the mode of function of a peristaltic system according to the embodiment of the invention as shown in FIGS. 4a) to c);

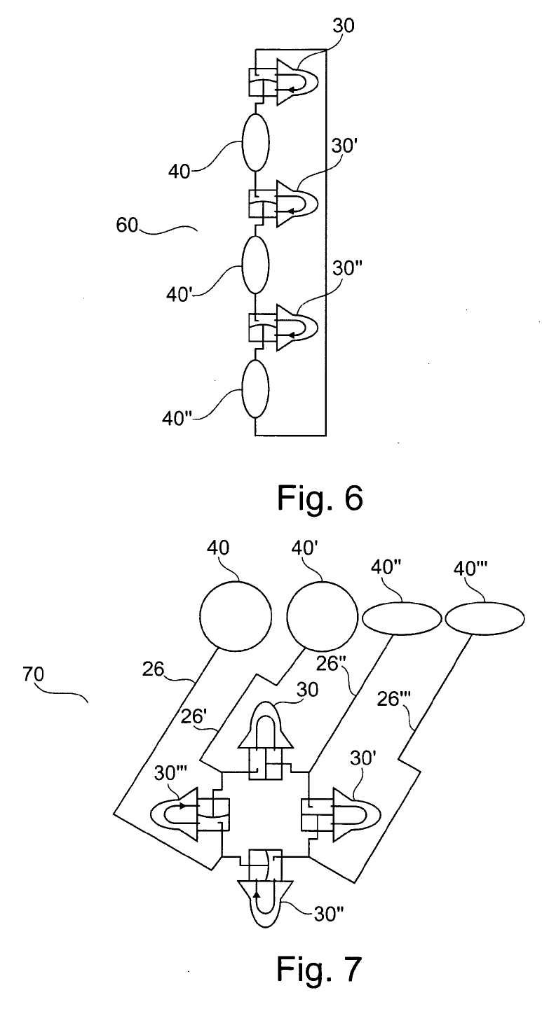

FIG. 6 shows a schematic representation of the peristaltic system according to the embodiment of the invention as shown in FIGS. 4a) to c) in the initial state;

FIG. 7 shows a schematic representation of a peristaltic system according to a further embodiment of the invention;

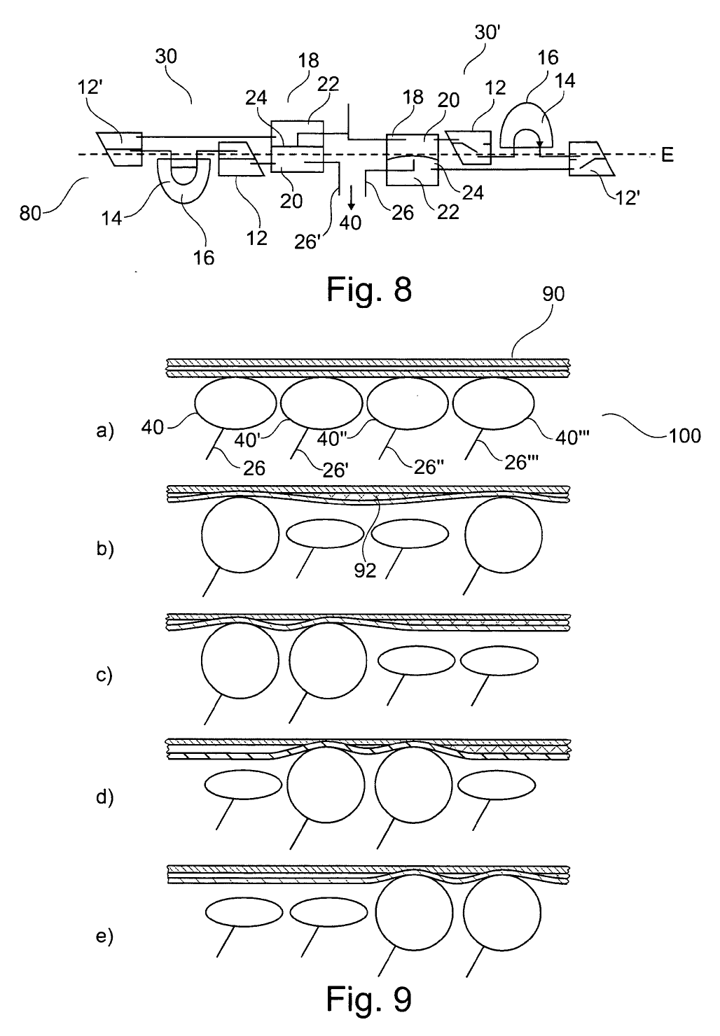

FIG. 8 shows a schematic representation of a peristaltic system according to a further embodiment of the invention;

FIGS. 9a) to e) show a schematic representation of the mode of function of a fluid delivery device according to an embodiment of the invention;

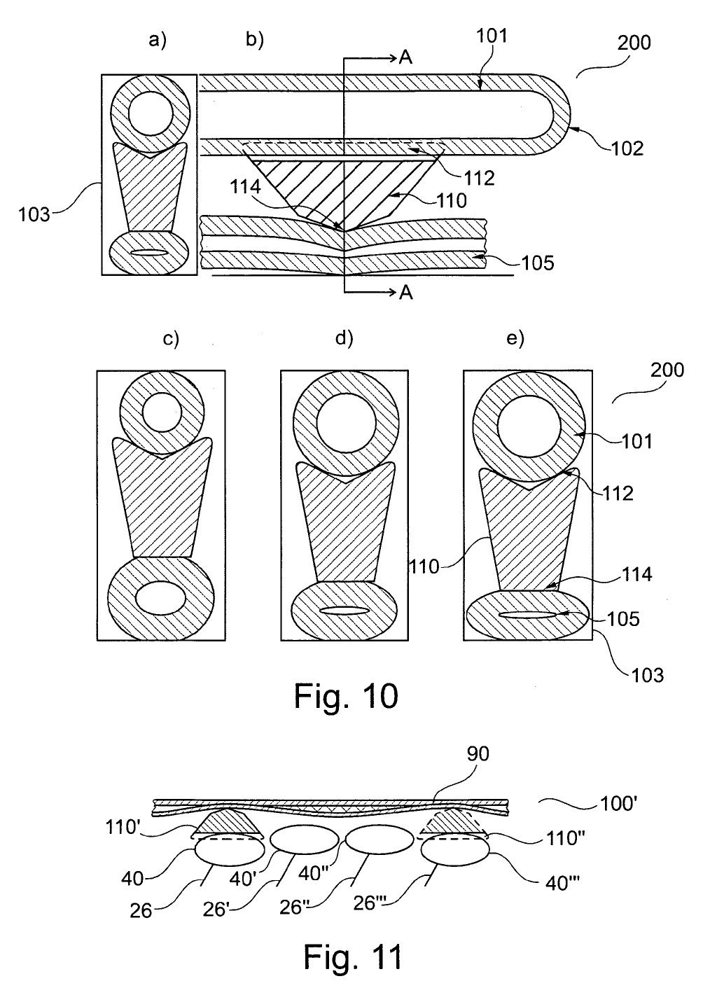

FIGS. 10a) to e) show a schematic representation of the mode of function of a hydraulically enforced valve, in which a peristaltic system according to invention is used; and

FIG. 11 shows a schematic representation of the mode of function of a fluid delivery device according to a further embodiment of the invention.

FIGS. 1a) to c) show a schematic representation of a pump 10 having a pump chamber 14, two check valves 12, 12′, one of which 12 is arranged in fluid connection with an inlet of the pump chamber 14, and the other of which 12′ is arranged in fluid connection with an outlet of the pump chamber 14, and a pump element (active pump chamber wall) 16 that is configured as a membrane integrally connected to the pump chamber 14. The membrane 16 can be deformed, for example, by means of a piezoelectric element (not shown) provided on the membrane 16 by applying a voltage to the element so as to suction a fluid into or displace a fluid out of the pump chamber 14. The membrane 16 can be formed, for example, of a metal or a plastic.

Reference numbers p1 and p2 indicate a pressure at the inlet side of the pump (supply pressure p1) and a pressure at the outlet side (back pressure p2) of the pump 10, respectively. As is shown in FIG. 1a), when the pump 10 is switched on, i.e., for example, when an AC voltage is applied to the piezoelectric element, a fluid delivery flow 11 flows in the direction indicated with an arrow since the check valves 12, 12′ allow a fluid through in this direction. Since the pump 10 is in operation, the supply pressure p1 is lower than the back pressure p2. If the pump is switched off and if p1 thereby remains smaller than p2, the check valves 12, 12′ will in this case reliably prevent a flow of fluid in the opposite direction to the delivery direction since they close in this direction (see FIG. 1b)).

A pump 10 constructed as shown in FIGS. 1a) to c) is always open for a flow of fluid in the delivery direction, i.e. even when the pump 10 is switched off. If p1 is greater than p2 (cf. FIG. 1c)), although the pump 10 exhibits a certain flow resistance in the delivery direction, it is, however, nonetheless open and thus a flow of fluid in the delivery direction can also occur when the pump 10 is switched off. This so-called “free flow” can have a serious disadvantage for many applications since uncontrolled streams of fluid in the idle state of the pump can occur. This can lead to considerable problems, in particular when using the pump 10 in a peristaltic system, since a precise dosage of the fluid as well as a precisely defined state of the system even in its idle state are required here.

This problem of “free flow” is solved by the pumps 30 used in the peristaltic system as according to the invention by providing a valve 18 (NC valve), which is closed in the idle state of the pump 30, in fluid connection with the check valves 12, 12′ (see FIGS. 2a) and 2b)). The remaining pump elements 12, 12′, 14 and 16 of the pump 30 shown in FIGS. 2a) and b) are identical to those of the pump 10 shown in FIGS. 1a) and b). The NC valve 18 comprises a chamber 20 that is in fluid connection with the check valve 12 at the inlet of the pump chamber 14, and a chamber 22 that is in fluid connection with the check valve 12′ at the outlet of the pump chamber 14, as well as a membrane 24 that is arranged between these chambers 20, 22, by means of which the chambers 20 and 22 are separated from one another. If, when the pump 18 is switched off, the supply pressure p1 is greater than the back pressure p2, as is shown in FIG. 2a), the membrane 24 closes the outlet of the valve 18 and thus reliably prevents a flow of fluid in the delivery direction. When the pump 30 is switched on, the membrane 24 is deformed if the pressure p2 in the chamber 22 at the outlet side of the pump chamber (14) exceeds the pressure p1 in the chamber 20 at the inlet side of the pump chamber (14) by a predetermined value dp, i.e. as soon as the pump has generated a certain excess pressure, as a result of which the valve 18 opens and also remains open for as long as this excess pressure exists (see FIG. 2b)).

FIGS. 3a) and b) show a schematic representation of a peristaltic system 50 according to an embodiment of the invention. The system 50 comprises two separately actuatable pumps 30, 30′, which are configured as shown in FIGS. 2a) and b), and a container 40 that is arranged in fluid connection with an inlet of the one pump 30′ and with an outlet of the other pump 30. The container 40 is balloon-shaped and is made of a flexible and resilient material, such as, for example, rubber, the volume thereof being dependent on the volume of the received fluid. The system 50 can be configured such that it is open or closed by optionally connecting the fluid lines 26″ and 26″′ to, for example, a fluid reservoir, the environment or with one another.

In order to supply a fluid to the container 40 and to thus increase its volume, the pump 30′, as shown in FIG. 3a), is brought into the idle state and the pump 30 is switched on. As a result hereof, a fluid is transported into the container 40 by the pump 30 via a fluid line 26, such as a tube, whilst the escape of the fluid out of the container 40 via a further fluid line 26′ and the pump 30′ is reliably prevented by the NC valve 18 of this pump 30′. In this manner, the volume of fluid received in the container 40 and thus also the volume of the container 40 can be increased.

In order to discharge the fluid out of the container 40 and to thus reduce its volume, the pump 30, as is shown in FIG. 3b), is brought into the idle state and the pump 30′ is switched on. In this manner, the fluid is suctioned out of the container 40 via the fluid line 26′ by means of the pump 30′, whilst no fluid can be transported into the container 40 via the fluid line 26 and the switched-off pump 30 since the NC valve 18 of this pump 30 closes. Thus, the volume of fluid received in the container 40 and hence also the volume of the container 40 can be reduced.

FIGS. 4a) to c) show a schematic representation of a peristaltic system 60 according to a further embodiment of the invention. The system 60 has the same fundamental structure as the system 50 shown in FIGS. 3a) and b), however it comprises three separately actuatable pumps 30, 30′, 30″, which are configured as shown in FIGS. 2a) and b), and three balloon-shaped flexible containers 40, 40′, 40″. The container 40″ is in fluid connection (see also FIGS. 5a) to l) and FIG. 6) with the pump 30 via a fluid line 26 which is shown in FIG. 4c) and is configured preferably as a tube (but which is not shown in FIGS. 4a) and b) in order to simplify the representation), and thus the system 60 is configured in a closed manner. As is apparent from FIGS. 4a) to c), the position of the container 40 or 40′ or 40″ can be changed with an increased volume by means of a suitable actuation of the pumps 30, 30′ and 30″. For example, once the container 40 has been supplied with a fluid by means of the pump 30 and once its volume has thus been increased (see FIG. 4a)), the pump 30 can, as shown in FIG. 4b), be brought into the idle state and the pump 30′ can be switched on. In this manner, the fluid received in the container 40 is suctioned out of the container 40 by means of the pump 30′ and transported into the container 40′, whilst an escape of the fluid out of the container 40′ via the pump 30″ is reliably prevented by the NC valve 18 of this pump 30″. In a similar manner, the fluid received in the container 40′ can be subsequently transported into the container 40″ by operating the pump 30″, as is shown in FIG. 4c). Thus, the position of the “inflated” container 40, 40′ 40″ can be varied in a targeted and periodically repeated manner, which enables, for example, the use of the peristaltic system 60 in a fluid delivery or massage device.

FIGS. 5a) to l) show a schematic representation of the mode of function of a peristaltic system according to the embodiment of the invention as shown in FIGS. 4a) to c). In contrast to the case shown in FIGS. 4a) to c), the position of two inflated containers 40, 40′, 40″ is, however, changed in the operation of the system 60 as shown in FIGS. 5a) to l) by a suitable actuation of the pumps 30, 30′, 30″, whereby at each point of the operation at least one of the containers 40, 40′, 40″ is completely inflated. The shifting or exchange of the inflated container 40, 40′, 40″ can hereby take place, depending on the actuation of the pumps, either in the counterclockwise direction, as is shown in FIGS. 5a) to f), or in the clockwise direction, as is shown in FIGS. 5g) to l). This allows a simple reversal of the delivery direction when using the peristaltic system 60 in a fluid delivery device. If all of the pumps 30, 30′, 30″ are switched on (activated) at the same time, the fluid loop is open, and thus a pressure equalization takes place between the three containers 40, 40′, 40″ and these assume the same volume (see FIG. 6). A defined initial state of the system 60 can therefore be achieved in a simple manner.

FIG. 7 shows a schematic representation of a peristaltic system 70 according to a further embodiment of the invention, which comprises four separately actuatable pumps 30, 30′, 30″, 30″′, which are configured as shown in FIGS. 2a) and b), and four balloon-shaped flexible containers 40, 40′, 40″, 40″′. In this embodiment, the pumps 30, 30′, 30″, 30″′ are combined in a circular system group and are in fluid connection with the containers 40, 40′, 40″, 40″′ via four, as compared to the structure shown in FIGS. 5a) to l) and FIG. 6, longer fluid lines 26, 26′, 26″, 26″′ that are preferably configured as tubes. Such a structure enables a spatial separation of the pumps 30, 30′, 30″, 30″′ and the containers 40, 40′, 40″, 40″′, and thus allows the containers 40, 40′, 40″, 40″′ to be located in places that are difficult to access and in areas with a small volume. The remaining structure and the mode of function of the system 70 are identical to those of the system 60 as shown in FIGS. 5a) to l) and FIG. 6.

FIG. 8 shows a schematic representation of a peristaltic system 80 according to a further embodiment of the invention, in which two pumps 30, 30′ are arranged next to one another in a plane E and which, via fluid lines 26, 26′, are in fluid connection with a container 40 that is not shown in this figure. In order to keep the elements 12, 12′, 14, 16 and 18 of the pumps 30, 30′ in their position relative to one another, they can, for example, be mounted on a planar carrier substrate, such as, for instance, a semiconductor, ceramic, plastic or metal substrate, whereby in order to achieve a particularly high packing density the substrate can also be provided with pump elements 12, 12′, 14, 16, 18 on both sides. The mode of function of system 80 is the same as that of system 50 as shown in FIGS. 3a) and b). However, the planar arrangement of the pumps 30, 30′ allows a particularly compact, space-saving and stable construction of the system 80 and is therefore very well suited to use in MEMS.

FIGS. 9a) to e) show a schematic representation of the mode of function of a fluid delivery device 100 according to an embodiment of the invention. The fluid delivery device 100 comprises the peristaltic system 70 as shown in FIG. 7, of which only the containers 40, 40′, 40″, 40″′ and the fluid lines 26, 26′, 26″, 26″′ are shown in FIGS. 9a) to e), as well as a deformable channel 90 that is suitable for receiving a fluid 92 and that is configured as a tube. As is shown in FIGS. 9a) to e), the channel 90 is arranged relative to the containers 40, 40′, 40″, 40″′ of the peristaltic system 70 such that a respective change in the volume of one of the containers 40, 40′, 40″, 40″′ causes a deformation of a portion of the channel 90 in the vicinity of the respective container 40, 40′, 40″, 40″′. Shown in FIG. 9a) is a defined initial state of the system 70, which is achieved by switching on all of the pumps (not shown) of the system 70 at the same time (see also FIG. 6). By means of a suitable actuation of the pumps, which can be carried out, for example, analogously with the operating procedure shown in FIGS. 5a) to f), a suitable variation of the volumes of the different containers 40, 40′, 40″, 40″′ and thus a time-varying deformation of the channel 90 can be achieved. In this manner, a fluid 92 received in the channel 90 can be moved along the channel 90 (from left to right in FIGS. 9a) to e)) and thus delivered. The fluid delivery device 100 has a particularly simple structure and enables the delivery also of small amounts of fluid with high precision, which is advantageous in particular for use in pipetting devices.

In a similar manner, the peristaltic system according to the invention can also be used, for example, for a sleeve that is suitable in particular for lymph drainage. In this case, a swollen area of a patient's body is massaged by a periodical variation of the container volumes carried out as described above so as to achieve drainage of the area. The peristaltic system can furthermore also be used as a means for stimulating blood circulation, for example as part of an anti-embolism stocking, support stocking or compression stocking. The compact and simple structure of the system according to the invention is particularly advantageous in such mobile applications.

FIGS. 10a) to e) show a schematic representation of the mode of function of a hydraulically enforced valve 200, in which a peristaltic system according to the invention is used. The hydraulically enforced valve 200 comprises two flexible tubes 101, 105 that are arranged together with an intermediate piece 110 in a fixed frame or pipe 103, with FIG. 10b) showing a cross-section of the valve 200 in a plane that is defined by the longitudinal axes of the tubes 101, 105, and with FIG. 10a) and FIGS. 10c) to e) showing cross-sectional representations along the line A-A in FIG. 10b).

The tube 101 arranged at the top in FIG. 10b) is flexibly configured at least in parts and is closed at its right end 102 (in FIG. 10 b)) such that its volume depends on the volume of received fluid, whereby it increases its diameter under an elevated internal pressure and reduces its diameter under a reduced internal pressure. The upper tube 101 is therefore used as a container of the peristaltic system according to the invention. The intermediate piece 110 is arranged between the upper tube 101 and the lower tube 105 such that it is in contact with both tubes 101, 105 at least in the enlarged (“inflated”) state of the upper tube 101, and is preferably made of a rigid material such as, for example, metal, ceramic or plastic. By receiving fluid into or discharging fluid out of the upper tube 101, the diameter thereof can thus be modified in a targeted manner, as a result of which a pressure exerted by the upper tube 101 on the lower tube 105 via the intermediate piece 110 is accordingly varied. The rigid pipe 103 hereby acts as a counter-bearing for the tubes 101, 105. As is shown in FIGS. 10c) to e), the lower tube 105 can therefore be compressed to the desired extent by a lateral pressure generated in such a manner on its contact area with the intermediate piece 110, which enables the precise control of a flow of fluid through the tube 105. For example, in the state shown in FIG. 10e), the lower tube 105 is completely clamped off so that a flow of fluid is not possible, i.e. the valve 200 is closed. It is hereby particularly advantageous for the intermediate piece 110 to be configured such that its contact area 112 with the tube 101 used as the container of the peristaltic system is larger than its contact area 114 with the tube 105, which carries a flow of fluid to be controlled, as a result of which the effect of the internal pressure of the tube 101 on the wall of the tube 105 can be increased. For example, in the embodiment shown in FIGS. 10a) to e), the intermediate piece 110 presses with a narrow edge 114 against the tube 105 transversely to the tube axis, whereas the contact area 112 of the intermediate piece 110 which contacts the tube 101 is considerably larger (FIG. 10b)), as a result of which the pressure exerted on the lower tube 105 and thus also the reliability and the efficiency of the valve 200 are significantly increased.

As was stated in detail above, a hydraulically enforced valve 200 can be realized with the arrangement of tubes 101, 105 as shown in FIGS. 10a) to e). The arrangement of the tubes 101, 105 thereby does not necessarily have to be parallel, as is shown in this example. However, precisely such a configuration enables a very compact structure of the valve 200. In principle, it is also possible to configure the hydraulically enforced valve 200 without an intermediate piece 110 in such a manner that a flexible container can directly exert pressure on a tube conveying a fluid. In such a construction, the upper tube 101 and the lower tube 105 could, for example, be arranged such that the longitudinal axes thereof are substantially perpendicular to one another.

FIG. 11 shows a schematic representation of the mode of function of a fluid delivery device 100′ according to a further embodiment of the invention. The structure of the fluid delivery device 100′ as shown in this figure is largely identical to that of the fluid delivery device 100 as shown in FIGS. 9a) to e), however in the present embodiment, intermediate pieces 110′, 110″ are used for transferring pressure between the containers 40, 40″′ and the tube 90. The intermediate pieces 110′, 110″ are configured substantially identically to the intermediate piece 110 shown in FIGS. 10a) to e) and are therefore used to increase the pressure exerted on the tube 90, as a result of which the reliability and efficiency of the fluid delivery device 100′ can be increased.

The fluid delivery device 100′ as shown in FIG. 11 therefore offers an increased clamping force on the tube 90, in particular at its end portions. However, depending on the field of use of the delivery device 100′ and the requirements on its delivery efficiency, corresponding further intermediate pieces may also be provided on the containers 40′, 40″ arranged in the middle of the device 100′.

The invention is not limited to the described embodiments but can rather be modified within the scope of the following patent claims.

1. A peristaltic system comprising:
at least two separately actuatable pumps, which each comprise:
a pump chamber suitable for receiving a fluid,
a pump element suitable for suctioning and displacing a fluid into and out of the pump chamber,
two check valves, one of which is arranged in fluid connection with an inlet of the pump chamber and the other of which is arranged in fluid connection with an outlet of the pump chamber, and
a valve that is closed in the idle state of the pump and is arranged in fluid connection with the check valves, and
a container suitable for receiving a fluid, which is arranged in fluid connection with an inlet of the one pump and with an outlet of the other pump,
wherein the container is flexibly configured, at least in parts, in such a manner that its volume depends on the volume of a received fluid.

2. The peristaltic system according to claim 1, wherein the pumps and the container form a closed fluid system.

3. The peristaltic system according to claim 1, wherein the valve in at least one of the pumps comprises two chambers, one of which is in fluid connection with the check valve at the inlet of the pump chamber and the other of which is in fluid connection with the check valve at the outlet of the pump chamber, and a membrane arranged between said chambers, said membrane being configured such that it deforms when the pressure in the chamber at the outlet side exceeds the pressure in the chamber at the inlet side by a predetermined value, as a result of which the valve opens.

4. The peristaltic system according to claim 1, wherein in at least one of the pumps, the pump element is a membrane.

5. The peristaltic system according to claim 1, wherein in at least one of the pumps, the check valves, the valve and the pump chamber and/or the pump element are arranged in one plane.

6. The peristaltic system according to claim 1, wherein at least one of the pumps is a micropump.

7. The peristaltic system according to claim 1, wherein the container is made of a plastic.

8. The peristaltic system according to claim 1, which comprises more than two pumps and at least two containers, wherein each of the containers is respectively arranged in fluid connection with the inlet of one of the pumps and with the outlet of another one of the pumps.

9. A fluid delivery device comprising:
a peristaltic system according to claim 8, and
a deformable channel suitable for receiving a fluid,
wherein said channel is arranged relative to the containers of the peristaltic system such that a respective change in the volume of one of the containers of the peristaltic system is suitable for bringing about a deformation of a portion of the channel in the vicinity of the corresponding container.

10. A fluid delivery device according to claim 9, wherein the containers are configured as areas of a pipe and the deformable channel is arranged within said pipe.

11. A pipetting device comprising at least one fluid delivery device according to claim 9.

12. A sleeve, in particular for lymph drainage, which comprises at least one peristaltic system according to claim 1.

13. A method for operating a peristaltic system according to claim 1, which comprises the steps of:
actuating the pump, the inlet of which is in fluid connection with the container, in order to bring this pump into the idle state,
actuating the pump, the outlet of which is in fluid connection with the container, in order to operate this pump such that a fluid is supplied to the container,
subsequently actuating the pump, the outlet of which is in fluid connection with the container, in order to bring this pump into the idle state, and
actuating the pump, the inlet of which is in fluid connection with the container, in order to operate this pump such that the fluid is discharged out of the container.

14. The method according to claim 13 for operating a peristaltic system which comprises more than two pumps and at least two containers, wherein each of the containers is respectively arranged in fluid connection with the inlet of one of the pumps and with the outlet of another one of the pumps, wherein the method steps are carried out in a predetermined sequence for each of the containers.
